(19) United States
(12) Patent Application Publication
(10) Pub. No.: US 2003/0156712 A1
(43) Pub. Date: Aug. 21, 2003

(54) Cellular phone holder capable of an electric charging

(76) Inventor: Suh-Young Kim, KwangJu-City (KR)

Correspondence Address: BURNS DOANE SWECKER & MATHIS L L P, POST OFFICE BOX 1404, ALEXANDRIA, VA, 22313-1404, US

(21) Appl. No.: 10/064,028

(22) Filed: Jun. 4, 2002

(30) Foreign Application Priority Data
Feb. 20, 2002 (WO) PCT/KR02/00263

(51) Int. Cl. H04M 1/00

(52) U.S. Cl. 379/441

(57) ABSTRACT

The present invention relates to a portable holder for a mobile phone, which can be recharged without additional charger and have radio frequency receiving and LD playing functions. The holder for a mobile phone comprises a radio receiver 20 installed at the rear of the holder 10, for receiving AM/FM frequency; a battery receiving box 30 installed at the rear of the holder 10 and into which a battery 31 of a given voltage is received; a rechargeable terminal 12 formed within a mobile phone receiving groove 111 of the holder 10 and charged by the battery 31; a LD player 40 installed on the top of the radio receiver 20 and the battery receiving box 30, for allowing given LD music; and a latch 50 installed on the top of the LD player 40 and thus mountable to a part of a human's body.

### CROSS REFERENCE TO RELATED APPLICATIONS

This application claims priority under 35 U.S.C. §§119 and/or 365 to Application No. PCT/KRO2/00263 filed in the Republic of Korea on Feb. 29, 2002; the entire content of which is hereby incorporated by reference.

### BACKGROUND OF INVENTION

1. Field of the Invention

The invention relates generally to a holder for a mobile phone, and more particularly to a portable holder for a mobile phone, which can be recharged without additional charger and have radio frequency receiving and LD playing functions.

2. Description of the Prior Art

Generally, mobile phones are one of the products that have been highlighted recently. Many people carry the mobile phones to communicate with someone else, without restriction as to places for placing the call.

Referring now to FIG. 2, a general holder for the mobile phones will be described. In order to carry the mobile phone, a device is required, which includes a mobile phone insertion groove 200 into which the mobile phones can be inserted and a mobile phone holder 100 having a latch 300 that can be mounted to a part of a human's body.

However, there is a case that the power of the battery is consumed during movement. In this case, an additional charger must be carried in order to continue the use of the mobile phone. Also, during travel, there is a need to carry a radio receiver for receiving a radio frequency and a LD (Laser Disc) player for listening LD music.

### SUMMARY OF INVENTION

The present invention solves the above problems and an object of the present invention is to provide a portable holder for a mobile phone in which a mobile phone can be received, and which can be recharged without additional charger and can listens a radio receiver and LD music.

In order to accomplish the above object, a holder for a mobile phone according to the present invention, is characterized in that it comprises a radio receiver installed at the rear of the holder, for receiving AM/FM frequency; a battery receiving box installed at the rear of the holder and into which a battery of a given voltage is received; a rechargeable terminal formed within a mobile phone receiving groove of the holder; a LD player installed on the top of the radio receiver and the battery receiving box, for allowing given LD music; and a latch installed on the top of the LD player, that is mounted to a part of a human's body.

### BRIEF DESCRIPTION OF DRAWINGS

The aforementioned aspects and other features of the present invention will be explained in the following description, taken in conjunction with the accompanying drawings, wherein:

FIG. 1 is an exploded assembly perspective of a rechargeable holder for a mobile phone according to the present invention; and

FIG. 2 is a perspective view of a general mobile holder.

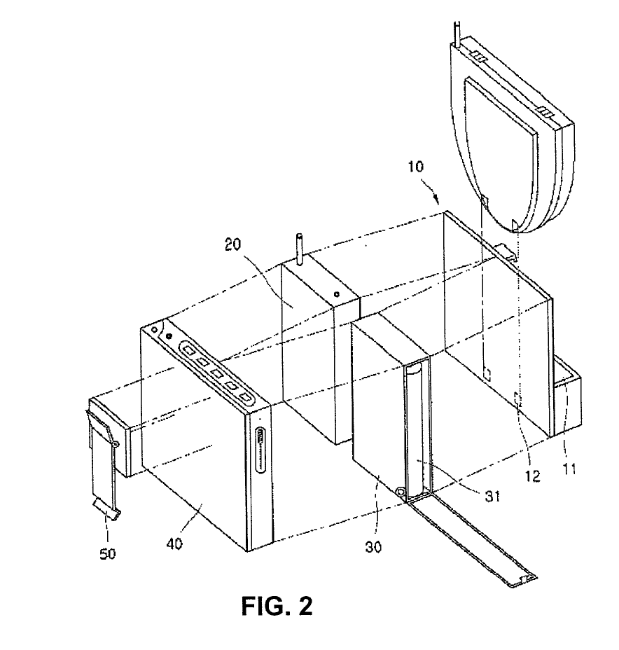

### DETAILED DESCRIPTION

The present invention will be described in detail by way of a preferred embodiment with reference to accompanying drawings.

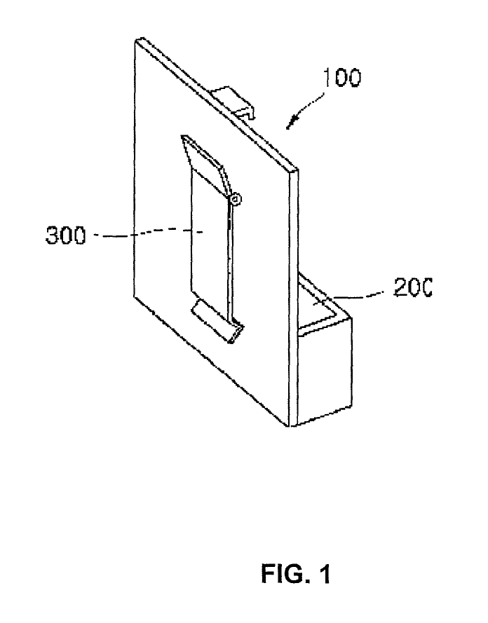

FIG. 1 is an exploded assembly perspective of a rechargeable holder for the mobile phone according to the present invention.

Referring now to FIG. 1, the rechargeable holder for the mobile phone according to the present invention will be below described.

The rechargeable holder includes a radio receiver 20, a batter receiving box 30, a LD player 40 and a latch 50 as a main component.

The radio receiver 20 for receiving AM/FM frequency is mounted at an internal rear of a mobile phone holder 10 having a mobile phone receiving groove 11 into which the mobile phone can be inserted.

The battery-receiving box 30 contains the battery 31 for charging a mobile phone battery and also contacts the rear of the mobile phone holder 10 and the side of the radio receiver 20.

Further, a rechargeable terminal 12 receives the power of the battery 31 in the battery receiving box 30 when the mobile phone is inserted into one side of the mobile phone receiving groove 11.

The LD player 40 is installed to simultaneously contact the sides of the radio receiver 20 and the battery receiving box 30. The latch 50 allows a part of a human's body or apparel to be mounted to one side of the LD player 40.

In addition, the battery 31 of the battery-receiving box 30 applies the power simultaneously to the radio receiver 20, and the LD player 40 and the mobile phone.

The battery 31 having a given voltage is inserted into the battery-receiving box 30 and the mobile phone is then assembled to the chargeable terminal 12 of the mobile phone holder 10.

At this time, the mobile phone battery is recharged by means of the rechargeable terminal 12 included at one side of the mobile phone holder 10. It is required that the battery 31 the power of which is completely consumed be replaced immediately.

Meanwhile, during a long-term travel, a radio broadcasting can be received using the radio receiver 20 having AM/FM reception function, that is included at the rear of the mobile phone holder 10 without additional radio receiver.

In addition, LD music can be listened using the LD player 40 at one side of the battery receiving box 30 and the radio receiver 20 by use of the battery 31.

As mentioned above, according to the present invention, the present invention has an advantage that it can charge a mobile phone charger, using a battery of a given voltage, if necessary, within a battery-receiving box of a mobile phone holder without additional charger. Further, the present invention has an outstanding effect that it can remove carrying of additional radio receiver and LD player during travel, by containing the radio receiver and the LD player at the holder for the mobile phone.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

1. A holder for a mobile phone for receiving a mobile phone, comprising:
a radio receiver installed at the rear of the holder, for receiving AM/FM frequency;
a battery-receiving box installed at the rear of the holder and into which a battery of a given voltage is received;
a rechargeable terminal formed within a mobile phone receiving groove of the holder, so that the battery can charge the terminal;
a LD (Laser Disc) player installed on the top of the radio receiver and the battery receiving box, for allowing given LD music; and
a latch installed on the top of the LD player and thus mountable to a part of a human's body or apparel.

2. A holder for a mobile phone for receiving a mobile phone, comprising:
a battery-receiving portion installed on the holder and into which a battery can be received;
a recharging terminal within the mobile phone receiving groove of the holder, so that a battery installed in the battery-receiving portion can recharge the mobile phone;
an auxiliary electronic device for producing sound from a source other than the mobile phone; and
a latch installed on the holder to be mountable to a part of a human's body or apparel.

3. A holder in accordance with claim 2, wherein the auxiliary electronic device is a laser disc player.

4. A holder in accordance with claim 2, wherein the auxiliary electronic device is a radio receiver for receiving AM/FM frequencies.

5. A holder in accordance with claim 2, wherein the auxiliary electronic device is both a radio receiver for receiver AM/FM frequencies and laser disc player for playing laser disc music.
